(19) United States
(12) Patent Application Publication
(10) Pub. No.: US 2016/0242162 A1
(43) Pub. Date: Aug. 18, 2016

(54) Dynamic Uplink/Downlink Configuration

(71) Applicant: NOKIA SIEMENS NETWORKS OY, Espoo (FI)

(72) Inventors: Chunhai YAO, Beijing (CN); Chunli WU, Beijing (CN); Benoist Pierre SEBIRE, Tokyo (JP)

(73) Assignee: Nokia Solutions and Networks Oy, Espoo (FI)

(21) Appl. No.: 15/029,728

(22) PCT Filed: Oct. 18, 2013
(86) PCT No.: PCT/CN2013/085459

§ 371 Date: Apr. 15, 2016

(51) Int. Cl. H04W 72/04; H04L 5/14; H04L 1/18

(52) U.S. Cl. CPC H04W 72/0406; H04L 1/1812; H04L 5/14

(57) ABSTRACT

A method includes monitoring, in a user terminal, a PDCCH channel during an active period of a DRX cycle. For defining a TDD configuration for the terminal when an inactive period of the DRX cycle changes into an active period, the method further includes monitoring downlink sub-frames and DwPTS sub-frames according to a downlink HARQ reference configuration until an update of the TDD configuration is received; monitoring the PDCCH channel for any sub-frames except for sub-frames scheduled or configured for uplink transmission by the downlink HARQ reference configuration until the update of the TDD configuration is received; and/or monitoring the PDCCH channel for sub-frames when the terminal monitors the PDCCH channel for paging. The method includes counting, in the terminal, PDCCH sub-frames for DRX timers, by utilizing the TDD configuration with the least or most downlink sub-frames for the PDCCH sub-frame counting

### FIELD OF THE INVENTION

The exemplary and non-limiting embodiments of this invention relate generally to wireless communications networks, and more particularly to uplink/downlink reconfiguration.

### BACKGROUND ART

The following description of background art may include insights, discoveries, understandings or disclosures, or associations together with dis-closures not known to the relevant art prior to the present invention but provided by the invention. Some such contributions of the invention may be specifically pointed out below, whereas other such contributions of the invention will be apparent from their context.

Time division duplex (TDD) refers to simultaneous and independent two-way transmission in which several signals are interleaved in time for transmission over a common frequency channel. In TDD the same frequency channel may be used for transmission in both directions, wherein both ends of a bi-directional connection alternate between transmitting and receiving bursts of data.

### SUMMARY

The following presents a simplified summary of the invention in order to pro-vide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise methods, an apparatus and a computer program product as defined in the independent claims. Further embodiments of the invention are disclosed in the dependent claims.

An aspect of the invention relates to a method for transmission control in a communications system, the method comprising monitoring, in a user terminal, a physical downlink control channel during an active period of a discontinuous reception DRX cycle; wherein, for defining a time division duplex TDD configuration for the user terminal when an inactive period of the discontinuous reception DRX cycle changes into the active period of the discontinuous reception DRX cycle, the method further comprises one or more of monitoring, in the user terminal, downlink sub-frames and DwPTS sub-frames according to a downlink HARQ reference configuration until an update of the time division duplex TDD configuration is received; monitoring, in the user terminal, the physical downlink control channel for any sub-frames except for sub-frames scheduled or configured for uplink transmission by the downlink HARQ reference configuration until the update of the time division duplex TDD configuration is received; and monitoring, in the user terminal, the physical downlink control channel for sub-frames when the user terminal monitors the physical downlink control channel for paging where time division duplex TDD configuration modification is sent.

A further aspect of the invention relates to a method for transmission control in a communications system, the method comprising counting, in a user terminal, physical downlink control channel PDCCH sub-frames for discontinuous reception DRX timers, wherein the method comprises utilizing, in the user terminal, the time division duplex TDD configuration with the least or most downlink sub-frames for the physical downlink control channel PDCCH sub-frame counting.

A still further aspect of the invention relates to an apparatus comprising at least one processor; and at least one memory including a computer program code, wherein the at least one memory and the computer program code are configured to, with the at least one processor, cause the apparatus to perform any of the method steps.

A still further aspect of the invention relates to a computer program product comprising program instructions which, when run on a computing apparatus, causes the computing apparatus to perform the method.

Although the various aspects, embodiments and features of the invention are recited independently, it should be appreciated that all combinations of the various aspects, embodiments and features of the invention are possible and within the scope of the present invention as claimed.

### BRIEF DESCRIPTION OF THE DRAWINGS

In the following the invention will be described in greater detail by means of exemplary embodiments with reference to the attached drawings, in which

FIG. 1 illustrates a DRX cycle;

FIG. 2 illustrates a possible TDD configuration modification with DRX;

FIG. 3 shows a simplified block diagram illustrating exemplary system architecture;

FIG. 4 shows a simplified block diagram illustrating exemplary apparatuses;

FIG. 5 shows a messaging diagram illustrating an exemplary messaging event according to an embodiment of the invention;

FIG. 6 shows a schematic diagram of a flow chart according to another exemplary embodiment of the invention.

### DETAILED DESCRIPTION OF SOME EMBODIMENTS

When small cells are deployed in the networks, each cell may have different traffics in uplink (UL) and downlink (DL). So it is possible that each cell determines its UL/DL configuration according to the cell's UL and DL traffics in a buffer. That is an objective of a 3GPP Release 12 feature “LTE TDD enhancement for DL-UL interference management and traffic adaptation (TDD-eIMTA)”.

Regardless of the UL/DL configuration indicated by SIB1 (system information block), an LTE base station eNB may change its UL/DL configuration to existing seven UL/DL configurations by using layer-1 (L1) signalling (PDCCH or ePDCCH), as shown below in Table 1 (D=active/downlink, U=active/uplink, S=inactive (“sleeping”)).

TABLE 1
current TDD UL/DL configurations

| UL/DL | Switching- | | | | | | | | | | |
|---|---|---|---|---|---|---|---|---|---|---|---|
| configu- | point | Subframe number | | | | | | | | | |
| ration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

For user equipment (UE) energy saving purposes, discontinuous reception (DRX) has been defined since Release 8. DRX refers to saving battery power in mobile stations by periodically/automatically switching a mobile station receiver on and off. DRX may be used for UE power saving as UE does not need to listen to a serving cell during DRX inactive periods, if there is no uplink or downlink data activity. If UE is configured with DRX by a higher layer, UE is not required to monitor (e)PDCCH when UE is not having an active period, as illustrated in FIG. 1. Also some timers are defined for DRX as shown in Table 2.

TABLE 2
DRX related timers

longDRX-CycleStartOffset
iongDRX-Cycle and drxStartOffset. The value of longDRX-Cycle is in number of sub-
frames. Value sf10 corresponds to 10 sub-frames, sf20 corresponds to 20 sub-
frames and so on. If shortDRX-Cycle is configured, the value of longDRX-Cycle is a
multiple of the shortDRX-Cycle value. The value of drxStartOffset value is in number
of sub-frames. In TDD, this may point to a DL or UL sub-frame.
onDurationTimer
Timer for DRX. Value in number of PDCCH sub-frames. Value psf1 corresponds to 1
PDCCH sub-frame, psf2 corresponds to 2 PDCCH sub-frames and so on.
drx-InactivityTimer
Timer for DRX. Value in number of PDCCH sub-frames. Value psf1 corresponds to 1
PDCCH sub-frame, psf2 corresponds to 2 PDCCH sub-frames and so on.
drx-RetransmissionTimer
Timer for DRX. Value in number of PDCCH sub-frames. Value psf1 corresponds to 1
PDCCH sub-frame, psf2 corresponds to 2 PDCCH sub-frames and so on.
shortDRX-Cycle
Short DRX cycle. Value in number of sub-frames. Value sf2 corresponds to 2 sub-
frames, sf5 corresponds to 5 subframes and so on.
drxShortCycleTimer
Timer for DRX. Value in multiples of shortDRX-Cycle. A value of 1 corresponds to
shortDRX-Cycle, a value of 2 corresponds to 2 * shortDRX-Cycle and so on.

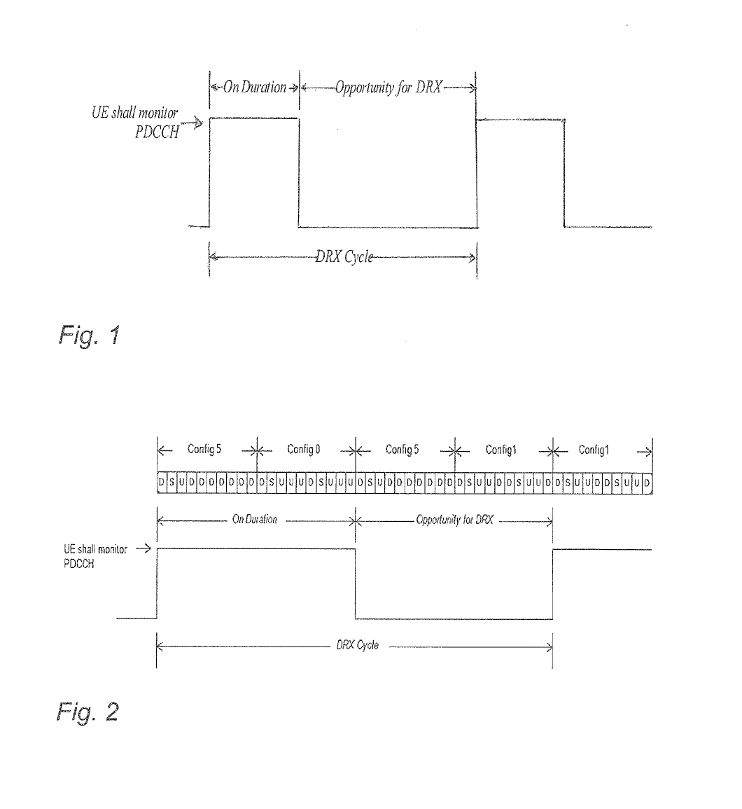

One issue is that if UE only monitors (e)PDCCH during the active time, UE may not have an up-to-date UL/DL configuration available when UE “wakes up” to monitor (e)PDCCH if UE missed UL/DL configuration modification when it was “sleeping” (i.e. during non-active time). UE may not be able to follow the new modified configuration to monitor PDCCH upon waking up from DRX until UE receives another update. As shown in FIG. 2, when UE wakes up at sub-frame #0 of the fifth radio frame, the UL/DL configuration is supposed to be configuration 1. However, the reconfiguration information may not be sent in the fifth radio frame or not even in the following radio frames, if the reconfigured UL/DL configuration is the same as in a previous radio frame. According to a RAN1 agreement “Explicit L1 signalling of reconfiguration by UE-group-common (e)PDCCH” reconfiguration signalling may be carried by downlink control information (DCI) in a common search space. If the reconfiguration information is sent in every radio frame, even the UL/DL configuration does not change. That causes a huge overhead in the common search space. In this case, UE waking up from asleep does not get the UL/DL configuration for a long period, causing misalignment between eNB and UE about which UL/DL configuration is to be applied.

Another issue is how to interpret a PDCCH sub-frame for the onDurationTimer, drx-RetransmissionTimer and drx-InactivityTimer when UE is configured for DRX, to ensure same understanding of the active time between UE and eNB. For TDD-eIMTA, the UL/DL configuration may be changed flexibly, meaning that the actual used UL/DL configuration may be changed several times when UE is sleeping. Even when UE is monitoring PDCCH, a possible missing of the UL/DL configuration update may cause a different understanding of the active time. Further as shown in FIG. 2, when UE is not having the active period, i.e. in the third radio frame, the UL/DL configuration (Config 5) is different from the configuration when UE is active (Config 0), and it is possible that the configuration changed from 5 to 1 when UE was sleeping. The number of the PDCCH sub-frame in configuration 0, 5 and 1 is different, thus the interpretation of the PDCCH-subframe in DRX needs to be clarified to ensure the same understanding between eNB and UE.

Explicit L1 signalling regarding the UL/DL reconfiguration by UE-group-common (e)PDCCH may be provided. L1 signalling may be used to inform UE on the downlink sub-frames to detect (e)PDCCH, and possibly to measure CSI.

In an existing solution (“option 1”), UE is additionally required to monitor (potential) TDD configuration modification sub-frames regardless of whether UE is in the active time or non-active time (similar to waking up for paging). Alternatively, the potential TDD configuration modification sub-frames are also considered as the active time during which UE is to monitor PDCCH (considering the power consumption, this is applicable if the modification occasions are configured by a higher layer with e.g. hundreds of ms periodicity).

In an existing solution (“option A”), only DL sub-frames and DwPTS sub-frames of the TDD configuration indicated in SIB1 are counted as PDCCH-sub-frames for the DRX timers. For simplicity and to avoid error cases (“option C”), instead of counting the PDCCH sub-frames, every sub-frame may be counted for the timers regardless of whether the sub-frame is a DL sub-frame or a UL sub-frame. The DL sub-frames and the DwPTS sub-frames of the actual TDD configuration signalled by using the L1 signalling may be considered as the PDCCH sub-frames for the timers (“option D”).

An exemplary embodiment relates to DRX in a flexible TDD reconfiguration.

TDD Configuration Modification During the Non-Active Time

In an exemplary embodiment (“option 2”), UE uses the configuration according to a downlink HARQ reference configuration to monitor PDCCH when UE wakes up from DRX, until UE receives an update (optionally with a condition of UE missing any TDD configuration modification occasion that is supposed to be known by both eNB and UE).

In another exemplary embodiment (“option 3”), UE monitors PDCCH of each sub-frame except those configured/scheduled with UL transmission when UE wakes up from DRX, until UE receives an update.

In yet another exemplary embodiment (“option 4”), the TDD configuration modification is restricted to the sub-frames for which UE is monitoring PDCCH for other purposes, e.g. for paging. UE may be required to monitor a group RNTI for the TDD configuration as well for those sub-frames for which it monitors PDCCH e.g. for paging.

PDCCH Subframe Counting

In yet another exemplary embodiment (“option B”), the TDD configuration with least (or most) DL sub-frames among the seven configurations is used as a reference for the PDCCH sub-frame counting for the DRX timers (since it is possible to change within seven configurations and there is a risk of UE missing an update any time), i.e. the DL sub-frames and the DwPTS sub-frames of the TDD configuration #1 or #5 are considered as PDCCH sub-frames for the DRX timers.

In an exemplary embodiment, if the UL/DL configuration indicated by SIB1 is configuration 0, the DRX configuration and the UL/DL reconfigurations are as illustrated in FIG. 2 and Table 3.

TABLE 3
DRX configuration with UL/DL reconfiguration

| | active | | non-active | | |
|---|---|---|---|---|---|
| | time | | time | | |
| radio frame number | 0 | 1 | 2 | 3 | 4 |
| UL/DL configuration in e.g. | 5 | 0 | 5 | 1 | 1 |
| 10 ms reconfiguration periodicity | | | | | |
| UL/DL configuration in e.g. | 5 | 0 | 0 | 1 | 1 |
| 20 ms reconfiguration periodicity | | | | | |

For example, determining which UL/DL configuration is applied for activating a sleeping UE, may be carried out as follows:

With option 1: For example, if UL/DL reconfiguration information is sent in the common search space in sub-frame 0, then UE needs to wake up at sub-frame 0; after that UE gets into sleep again. As shown above in Table 3, if UL/DL reconfiguration periodicity is 10 ms (the same as in FIG. 2), UE needs to wake up at sub-frame 0 of each radio frame. Thus UE knows the updated UL/DL configuration even if UE is in DRX. After the wake-up from DRX in radio frame #4, UE reads the configuration information. If the information is not available, UE assumes the same UL/DL configuration as with a previous radio frame, i.e. configuration 1 in radio frame #3. If the UL/DL reconfiguration periodicity is 20 ms and the update configuration only happens in an odd radio frame, UE wakes up at sub-frame 0 of the odd radio frame to obtain the reconfigured UL/DL configuration. Then UE knows the configuration of radio frame #4 as shown in Table 3. With option 1, option D is possible as UE knows the UL/DL configuration every time.

With option 2: UE does not need to wake up in sub-frame 0 to listen for the UL/DL configuration. After DRX, UE assumes that the configuration is the same as the SIB1-indicated UL/DL configuration. In the example shown in FIG. 2 and Table 3, it may be possible that there is no UL/DL configuration indication in radio frame #4. Thus UE assumes that the current configuration is 0 as indicated by SIB1, until the update is obtained. So, UE behaviour is similar to that of a legacy UE.

With option 3: There is no UL/DL reconfiguration indication in radio frame #4 in the example shown in FIG. 2 and Table 3. UE monitors each possible DL sub-frame except those sub-frames configured for or scheduled as UL transmission in the radio frame #4, until the update is available.

For example, PDCCH sub-frame counting may be carried out as follows:

With option A: Only the DL sub-frames and DwPTS sub-frames of the TDD configuration indicated in SIB1 are counted as PDCCH sub-frames for the DRX timers. So, for the onDurationTimer, drx-InactivityTimer and drx-RetransmissionTimer, the number of PDCCH sub-frames is four in each radio frame, i.e. the same as the number of DL transmission sub-frames of SIB1 (configuration 0).

With option B: The TDD configuration with least (or most) DL sub-frames among the seven configurations is used as the reference for PDCCH sub-frame counting for the DRX timers. If a DL-heavy configuration 5 is configured as the reference for the PDCCH counting, so for the onDurationTimer, drx-InactivityTimer and drx-RetransmissionTimer, the number of PDCCH sub-frames is nine in each radio frame.

With option C: Every sub-frame is counted regardless of whether the sub-frame is a DL sub-frame or a UL sub-frame.

With solution D: As a precondition, UE needs to ensure every time that it has an up-to-date TDD configuration.

Thus, in an exemplary embodiment, when UE wakes up from DRX, UL/DL configuration confusion and network scheduling errors may be avoided, without impacting system performance. In an exemplary embodiment, the issue of PDCCH sub-frame counting misalignment between eNB and UE may be solved with minimum changes to the system.

Exemplary embodiments will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any user terminal, network node, server, corresponding component, and/or to any communication system or any combination of different communication systems that support discontinuous reception. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be applied, an architecture based on LTE (or LTE-A) (long term evolution (advanced long term evolution)) network elements, without restricting the embodiment to such an architecture, however. The embodiments described in these examples are not limited to the LTE radio systems but can also be implemented in other radio systems, such as UMTS (universal mobile telecommunications system), GSM, EDGE, WCDMA, bluetooth network, WLAN or other fixed, mobile or wireless network. In an embodiment, the presented solution may be applied between elements belonging to different but compatible systems such as LTE and UMTS.

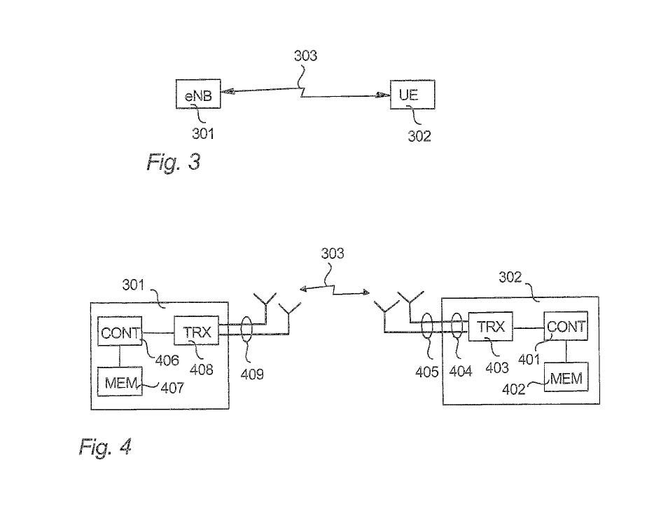

A general architecture of a communication system is illustrated in FIG. 3. FIG. 3 is a simplified system architecture only showing some elements and functional entities, all being logical units whose implementation may differ from what is shown. The connections shown in FIG. 3 are logical connections; the actual physical connections may be different. It is apparent to a person skilled in the art that the systems also comprise other functions and structures. It should be appreciated that the functions, structures, elements and the protocols used in or for discontinuous reception, are irrelevant to the actual invention. Therefore, they need not to be discussed in more detail here.

The exemplary radio system of FIG. 3 comprises a network node 301 of a network operator. The network node 301 may include e.g. an LTE base station (eNB), radio network controller (RNC), or any other network element, or a combination of network elements. The network node 301 may be connected to one or more core network (CN) elements (not shown in FIG. 3) such as a mobile switching centre (MSC), MSC server (MSS), mobility management entity (MME), gateway GPRS support node (GGSN), serving GPRS support node (SGSN), home location register (HLR), home subscriber server (HSS), visitor location register (VLR). In FIG. 3, the radio network node 301 that may also be called eNB (enhanced node-B, evolved node-B) or network apparatus of the radio system, hosts the functions for radio resource management in a public land mobile network. FIG. 3 shows one or more user equipment 302 located in the service area of the radio network node 301. The user equipment refers to a portable computing device, and it may also be referred to as a user terminal. Such computing devices include wireless mobile communication devices operating with or without a subscriber identification module (SIM) in hardware or in software, including, but not limited to, the following types of devices: mobile phone, smart-phone, personal digital assistant (PDA), handset, laptop computer. In the example situation of FIG. 3, the user equipment 302 is capable of connecting to the radio network node 301 via a connection 303.

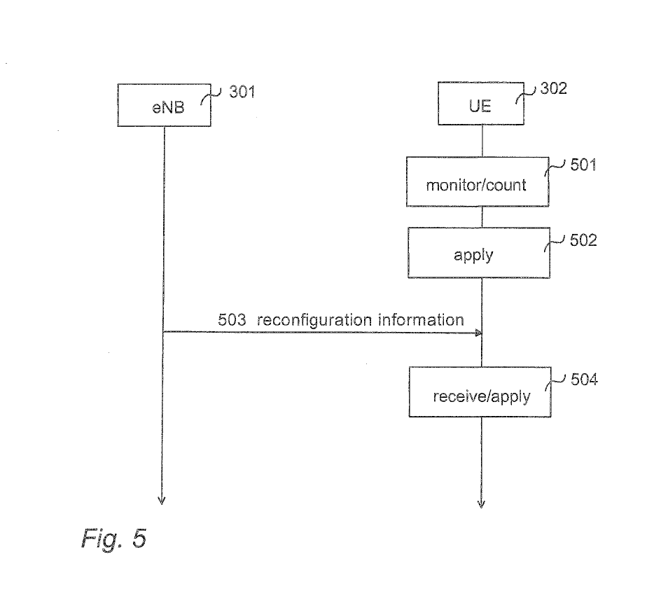

FIG. 4 is a block diagram of an apparatus according to an embodiment of the invention. FIG. 4 shows a user equipment 302 located in the area of a radio network node 301. The user equipment 302 is configured to be in connection with the radio network node 301. The user equipment or UE 302 comprises a controller 401 operationally connected to a memory 402 and a transceiver 403. The controller 401 controls the operation of the user equipment 402. The memory 402 is configured to store software and data. The transceiver 403 is configured to set up and maintain a wireless connection 303 to the radio network node 401. The transceiver 403 is operationally connected to a set of antenna ports 404 connected to an antenna arrangement 405. The antenna arrangement 405 may comprise a set of antennas. The number of antennas may be one to four, for example. The number of antennas is not limited to any particular number. The user equipment 302 may also comprise various other components, such as a user interface, camera, and media player. They are not displayed in the figure due to simplicity. The radio network node 301, such as an LTE base station (eNode-B, eNB) comprises a controller 406 operationally connected to a memory 407, and a transceiver 408. The controller 406 controls the operation of the radio network node 301. The memory 407 is configured to store software and data. The transceiver 408 is configured to set up and maintain a wireless connection to the user equipment 302 within the service area of the radio network node 301. The transceiver 408 is operationally connected to an antenna arrangement 409. The antenna arrangement 409 may comprise a set of antennas. The number of antennas may be two to four, for example. The number of antennas is not limited to any particular number. The radio network node 301 may be operationally connected (directly or indirectly) to another network element (not shown in FIG. 4) of the communication system, such as a radio network controller (RNC), a mobility management entity (MME), an MSC server (MSS), a mobile switching centre (MSC), a radio resource management (RRM) node, a gateway GPRS support node, an operations, administrations and maintenance (OAM) node, a home location register (HLR), a visitor location register (VLR), a serving GPRS support node, a gateway, and/or a server, via an interface.

The embodiments are not, however, restricted to the network given above as an example, but a person skilled in the art may apply the solution to other communication networks provided with the necessary properties. For example, the connections between different network elements may be realized with internet protocol (IP) connections.

Although the apparatus 301, 302 has been depicted as one entity, different modules and memory may be implemented in one or more physical or logical entities. The apparatus may also be a user terminal which is a piece of equipment or a device that associates, or is arranged to associate, the user terminal and its user with a subscription and allows a user to interact with a communications system. The user terminal presents information to the user and allows the user to input information. In other words, the user terminal may be any terminal capable of receiving information from and/or transmitting information to the network, connectable to the network wirelessly or via a fixed connection. Examples of the user terminals include a personal computer, a game console, a laptop (a notebook), a personal digital assistant, a mobile station (mobile phone), a smart phone, and a line telephone.

The apparatus 301, 302 may generally include a processor, controller, control unit or the like connected to a memory and to various interfaces of the apparatus. Generally the processor is a central processing unit, but the processor may be an additional operation processor. The processor may com-prise a computer processor, application-specific integrated circuit (ASIC), field-programmable gate array (FPGA), and/or other hardware components that have been programmed in such a way to carry out one or more functions of an embodiment.

The memory 402, 407 may include volatile and/or non-volatile memory and typically stores content, data, or the like. For example, the memory 402, 407 may store computer program code such as software applications (for example for the detector unit and/or for the adjuster unit) or operating systems, information, data, content, or the like for a processor to perform steps associated with operation of the apparatus in accordance with embodiments. The memory may be, for example, random access memory (RAM), a hard drive, or other fixed data memory or storage device. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g. procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

The signalling chart of FIG. 5 illustrates the required signalling. In the example of FIG. 5, a network node 302 (e.g. a user terminal, UE) is configured to monitor 501 a physical downlink control channel for defining a time division duplex TDD configuration for the user terminal when an inactive period of the discontinuous reception DRX cycle changes into the active period of the discontinuous reception DRX cycle. The user terminal may monitor 501 downlink sub-frames and DwPTS sub-frames according to a downlink HARQ reference configuration until an update of the time division duplex TDD configuration is received. The user terminal may monitor 501 the physical downlink control channel for any sub-frames except for sub-frames scheduled or configured for uplink transmission by the downlink HARQ reference configuration until the update of the time division duplex TDD configuration is received. The user terminal may monitor 501 the physical downlink control channel for sub-frames when the user terminal monitors the physical downlink control channel for paging where TDD configuration modification is sent.

The user terminal 302 is configured to count 501 physical downlink control channel PDCCH sub-frames for discontinuous reception DRX timers. The user terminal may utilize 501 the time division duplex TDD configuration with the least or most downlink sub-frames for the physical downlink control channel PDCCH sub-frame counting. In item 502, the user terminal, may apply the defined time division duplex TDD configuration when the inactive period of the discontinuous reception DRX cycle changes into the active period of the discontinuous reception DRX cycle. In item 503, a network node 301 (which may comprise e.g. a LTE-capable base station (eNode-B, eNB)) may transmit a TDD configuration modification message to the user terminal 302. In item 504 the user terminal 302 may receive the TDD configuration modification message. In item 504, the user terminal, may apply an updated time division duplex TDD configuration based on the received TDD configuration modification message.

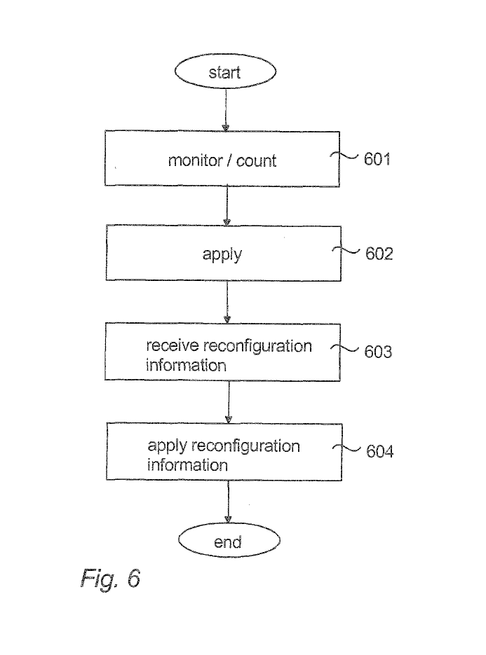

FIG. 6 is a flow chart illustrating an exemplary embodiment. The apparatus 302, which may comprise e.g. a network element (network node 302, e.g. a user terminal, UE) is configured to monitor 601 a physical downlink control channel for defining a time division duplex TDD configuration for the user terminal when an inactive period of the discontinuous reception DRX cycle changes into the active period of the discontinuous reception DRX cycle. The user terminal may monitor 601 downlink sub-frames and DwPTS sub-frames according to a downlink HARQ reference configuration until an update of the time division duplex TDD configuration is received. The user terminal may monitor 601 the physical downlink control channel for any sub-frames except for sub-frames scheduled or configured for uplink transmission by the downlink HARQ reference configuration until the update of the time division duplex TDD configuration is received. The user terminal may monitor 601 the physical downlink control channel for sub-frames when the user terminal monitors the physical downlink control channel for paging where TDD configuration modification is sent.

The user terminal 302 is configured to count 601 physical downlink control channel PDCCH sub-frames for discontinuous reception DRX timers. The user terminal may utilize 601 the time division duplex TDD configuration with the least or most downlink sub-frames for the physical downlink control channel PDCCH sub-frame counting. In item 602, the user terminal, may apply the defined time division duplex TDD configuration when the inactive period of the discontinuous reception DRX cycle changes into the active period of the discontinuous reception DRX cycle. In item 603, the user terminal 302 may receive a TDD configuration modification message from a network node 301 (which may comprise e.g. a LTE-capable base station (eNode-B, eNB)). In item 604, the user terminal, may apply an updated time division duplex TDD configuration based on the received TDD configuration modification message.

The steps/points, signalling messages and related functions de-scribed above in FIGS. 1 to 6 are in no absolute chronological order, and some of the steps/points may be performed simultaneously or in an order differing from the given one. Other functions can also be executed between the steps/points or within the steps/points and other signalling messages sent be-tween the illustrated messages. Some of the steps/points or part of the steps/points can also be left out or replaced by a corresponding step/point or part of the step/point. The server operations illustrate a procedure that may be implemented in one or more physical or logical entities. The signalling messages are only exemplary and may even comprise several separate messages for transmitting the same information. In addition, the messages may also contain other information.

Thus, an exemplary embodiment discloses a method for transmission control in a communications system, the method comprising monitoring, in a user terminal, a physical downlink control channel during an active period of a discontinuous reception DRX cycle; wherein, for defining a time division duplex TDD configuration for the user terminal when an inactive period of the discontinuous reception DRX cycle changes into the active period of the discontinuous reception DRX cycle, the method further comprises one or more of monitoring, in the user terminal, downlink subframes and DwPTS subframes according to a downlink HARQ reference configuration until an update of the time division duplex TDD configuration is received; monitoring, in the user terminal, the physical downlink control channel for any sub-frames except for sub-frames scheduled or configured for uplink transmission by the downlink HARQ reference configuration until the update of the time division duplex TDD configuration is received; and monitoring, in the user terminal, the physical downlink control channel for sub-frames when the user terminal monitors the physical downlink control channel for paging where time division duplex TDD configuration modification is sent.

Another exemplary embodiment discloses a method for transmission control in a communications system, the method comprising counting, in a user terminal, physical downlink control channel PDCCH sub-frames for discontinuous reception DRX timers, wherein the method comprises utilizing, in the user terminal, the time division duplex TDD configuration with the least or most downlink sub-frames for the physical downlink control channel PDCCH sub-frame counting.

Yet another exemplary embodiment discloses applying the defined time division duplex TDD configuration in the user terminal when the inactive period of the discontinuous reception DRX cycle changes into the active period of the discontinuous reception DRX cycle.

Yet another exemplary embodiment discloses applying the defined time division duplex TDD configuration in the user terminal when the inactive period of the discontinuous reception DRX cycle changes into the active period of the discontinuous reception DRX cycle until the user terminal receives an updated time division duplex TDD configuration.

In yet another exemplary embodiment, the discontinuous reception DRX timer comprises an on-duration timer, a DRX inactivity timer and/or a DRX retransmission timer.

Yet another exemplary embodiment discloses utilizing, in the user terminal, the time division duplex TDD configuration according to a first system information block SIB1 when the inactive period of the discontinuous reception changes into the active period of the discontinuous reception if the user terminal missed a TDD configuration modification occasion known by a base station and the user terminal.

Yet another exemplary embodiment discloses monitoring, in the user terminal, the physical downlink control channel for any sub-frames except for sub-frames scheduled or configured for uplink transmission, until the user terminal receives an update.

Yet another exemplary embodiment discloses monitoring, in the user terminal, the physical downlink control channel for sub-frames when the user terminal monitors the physical downlink control channel for paging, wherein the user terminal monitors a group RNTI for the TDD configuration at the respective sub-frames.

Yet another exemplary embodiment discloses an apparatus comprising at least one processor; and at least one memory including a computer program code, wherein the at least one memory and the computer program code are configured to, with the at least one processor, cause the apparatus to perform any of the method steps.

Yet another exemplary embodiment discloses a computer program product comprising program instructions which, when run on a computing apparatus, causes the computing apparatus to perform the method.

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS

PDCCH physical downlink control channel

ePDCCH enhanced physical downlink control channel

LTE-A long term evolution advanced

LTE long term evolution

eNB enhanced node-B

L1 layer-1

SIB system information block

DRX discontinuous reception

UL uplink

DL downlink

3GPP 3rd generation partnership project

TDD time division duplex

RNTI radio network temporary identifier

CSI channel state information

HARQ hybrid automatic repeat request

DwPTS downlink pilot time slot

1. A method for transmission control in a communications system, the method comprising
monitoring, in a user terminal, a physical downlink control channel during an active period of a discontinuous reception DRX cycle;
wherein, for defining a time division duplex TDD configuration for the user terminal, the method further comprises one or more of
monitoring, in the user terminal, downlink sub-frames and DwPTS sub-frames according to a downlink HARQ reference configuration until an update of the time division duplex TDD configuration is received;
monitoring, in the user terminal, the physical downlink control channel for any sub-frames except for sub-frames scheduled or configured for uplink transmission by the downlink HARQ reference configuration until the update of the time division duplex TDD configuration is received;
monitoring, in the user terminal, the physical downlink control channel for sub-frames when the user terminal monitors the physical downlink control channel for paging where time division duplex TDD configuration modification is sent; and
utilizing, in the user terminal, the time division duplex TDD configuration according to a first system information block SIB1 if the user terminal missed a TDD configuration modification occasion known by a base station and the user terminal.

2. A method for transmission control in a communications system, the method comprising
counting, in a user terminal, physical downlink control channel PDCCH sub-frames for discontinuous reception DRX timers
utilizing, in the user terminal, a time division duplex TDD configuration with the least or most downlink sub-frames for the physical downlink control channel PDCCH sub-frame counting.

3. A method as claimed in claim 1, characterized by
applying the defined time division duplex TDD configuration in the user terminal when the inactive period of the discontinuous reception DRX cycle changes into the active period of the discontinuous reception DRX cycle.

4. A method as claimed in claim 1, characterized by
applying the defined time division duplex TDD configuration in the user terminal when the inactive period of the discontinuous reception DRX cycle changes into the active period of the discontinuous reception DRX cycle until the user terminal receives an updated time division duplex TDD configuration.

5. A method as claimed in claim 2, characterized by
the discontinuous reception DRX timer comprising an on-duration timer, a DRX inactivity timer and/or a DRX retransmission timer.

6. (canceled)

7. A method as claimed in claim 1, characterized by monitoring, in the user terminal, the physical downlink control channel for any sub-frames except for sub-frames scheduled or configured for uplink transmission, until the user terminal receives an update.

8. A method as claimed in claim 1, characterized by monitoring, in the user terminal, the physical downlink control channel for sub-frames when the user terminal monitors the physical downlink control channel for paging, wherein the user terminal monitors a group RNTI for the TDD configuration at the respective sub-frames.

9. An apparatus comprising at least one processor; and at least one memory including a computer program code, characterized in that the at least one memory and the computer program code are configured to, with the at least one processor, cause the apparatus to perform any of the method steps of claim 1.

10. A non-transitory computer program product comprising program instructions which, when run on a computing apparatus, causes the computing apparatus to perform a method according to claim 1.

11. A method as claimed in claim 1, wherein for defining a time division duplex TDD configuration for the user terminal is performed in response to an inactive period of the discontinuous reception DRX cycle changes into the active period of the discontinuous reception DRX cycle.

12. A method as claimed in claim 1, wherein utilizing further comprises, in the user terminal, the time division duplex TDD configuration according to the first system information block SIB1 in response to an inactive period of the discontinuous reception DRX cycle changing into the active period of the discontinuous reception DRX cycle if the user terminal missed the TDD configuration modification occasion known by the base station and the user terminal.

13. A non-transitory computer program product comprising program instructions which, when run on a computing apparatus, causes the computing apparatus to perform a method according to claim 2.

14. An apparatus comprising:
at least one processor; and
at least one non-transitory memory including computer program code, the at least one memory and the computer program code configured to, with the at least one processor, cause the apparatus to:
monitor, in the apparatus, a physical downlink control channel during an active period of a discontinuous reception DRX cycle, wherein the apparatus comprises a user terminal, and wherein, for defining a time division duplex TDD configuration for the user terminal when an inactive period of the discontinuous reception DRX cycle changes into the active period of the discontinuous reception DRX cycle;
monitor, in the user terminal, downlink sub-frames and DwPTS sub-frames according to a downlink HARQ reference configuration until an update of the time division duplex TDD configuration is received;
monitor, in the user terminal, the physical downlink control channel for any sub-frames except for sub-frames scheduled or configured for uplink transmission by the downlink HARQ reference configuration until the update of the time division duplex TDD configuration is received;
monitor, in the user terminal, the physical downlink control channel for sub-frames when the user terminal monitors the physical downlink control channel for paging where time division duplex TDD configuration modification is sent; and
utilize, in the user terminal, the time division duplex TDD configuration according to a first system information block SIB1 when the inactive period of the discontinuous reception changes into the active period of the discontinuous reception when the user terminal missed a TDD configuration modification occasion known by a base station and the user terminal.
